(19) United States
(12) Patent Application Publication
(10) Pub. No.: US 2026/0065723 A1
(43) Pub. Date: Mar. 5, 2026

(54) VEHICLE COMPONENT CONTROL

(71) Applicant: Ford Global Technologies, LLC, Dearborn, MI (US)

(72) Inventors: Omar Makke, Oakland, MI (US); Oleg Gusikhin, Commerce Township, MI (US)

(73) Assignee: Ford Global Technologies, LLC, Dearborn, MI (US)

(21) Appl. No.: 18/824,179

(22) Filed: Sep. 4, 2024

(51) Int. Cl. G07C 5/08; G07C 5/00

(52) U.S. Cl. CPC G07C 5/0808; G07C 5/008; G07C 5/0825

(57) ABSTRACT

A computer includes a processor and a memory, and the memory stores instructions executable by the processor to, in response to a state of a vehicle satisfying a criterion, actuate a component of the vehicle according to a test control input; and determine a physical characteristic of the component based on data generated as a result of actuating the component according to the test control input. The test control input cycles a magnitude of actuation of the component more frequently than a standard control input cycles the magnitude of actuation. The standard control input is used for actuating the component while the state of the vehicle does not satisfy the criterion.

### BACKGROUND

Various components of vehicles may wear out over time and are replaced. For some components, the vehicle manual may specify a length of time or distance traveled by the vehicle at which to replace the components. For some components, an indicator in the vehicle may inform the operator that a component is recommended for replacement.

### BRIEF DESCRIPTION OF THE DRAWINGS

FIG. 1 is a block diagram of an example system including a vehicle communicating with a remote server.

FIG. 2 is a block diagram of an example architecture for controlling a component of the vehicle.

FIG. 3 is a flowchart of an example process for the computer to control the component and determine physical characteristics of the component.

FIG. 4 is a flowchart of an example process for the remote server to evaluate the physical characteristics of the component.

### DETAILED DESCRIPTION

This disclosure provides techniques for determining a physical characteristic of a component of the vehicle to enhance vehicle control and operation. Examples of physical characteristics include brake pad thickness, cabin air filter dust accumulation, engine airflow, windshield washer fluid pressure, etc. The physical characteristic may be an input in a control algorithm for the component, and/or the physical characteristic may indicate that the component should be serviced.

To determine the physical characteristic, a computer is programmed to actuate the component of the vehicle according to a test control input and determine the physical characteristic of the component based on data generated as a result of actuating the component according to the test control input. The test control input specifies a magnitude of actuation of the component, which is whether and how much the component is being actuated (e.g., a braking force of the brake system). The test control input cycles the magnitude of actuation of the component more frequently than a standard control input cycles the magnitude of actuation. The term “cycling” refers to reversing the magnitude of actuation (e.g., switching between braking and not braking or between a higher braking force and a lower braking force). The standard control input is what is used during typical operation of the vehicle. The more frequent cycling of the test control input can increase a likelihood of finding a globally optimal estimate for the physical characteristic rather than settling on a locally optimal estimate, thereby increasing an accuracy of the determined value for the physical characteristic.

Further, the computer is programmed to actuate the component according to the test control input in response to a state of the vehicle satisfying a criterion. The criterion is chosen to determine whether the setting of the vehicle is appropriate for the use of the test control input. For example, the criterion may include that the vehicle is unoccupied and/or that the component is currently activatable (e.g., for a climate-control system, that the vehicle is running and therefore able to actuate the climate-control system). The criterion can make it so that the test control input is unlikely to disturb occupants of the vehicle or others.

A computer includes a processor and a memory, and the memory stores instructions executable by the processor to, in response to a state of a vehicle satisfying a criterion, actuate a component of the vehicle according to a test control input; and determine a physical characteristic of the component based on data generated as a result of actuating the component according to the test control input. The test control input cycles a magnitude of actuation of the component more frequently than a standard control input cycles the magnitude of actuation. The standard control input is used for actuating the component while the state of the vehicle does not satisfy the criterion.

In an example, the test control input may include at least one periodic component.

In an example, the instructions may further include instructions to determine a plurality of physical characteristics of the component based on the data generated as a result of actuating the component according to the test control input. In a further example, the test control input may include a number of periodic components at least as great as a number of the physical characteristics of the component, the periodic components having different frequencies than each other.

In an example, the criterion may include that the vehicle lacks occupants. In a further example, the criterion may include that the component is currently activatable simultaneous with the vehicle lacking occupants.

In an example, the instructions may further include instructions to determine the physical characteristic by minimizing a difference between the data generated as a result of actuating the component according to the test control input and a reference model simulating the component.

In an example, the instructions may further include instructions to, in response to the state of the vehicle satisfying the criterion, transmit a message to a remote server indicating that the vehicle is ready to actuate the component according to the test control input. In a further example, the instructions may further include instructions to, in response to receiving the test control input from the remote server after transmitting the message to the remote server, actuate the component according to the test control input.

In an example, the instructions may further include instructions to transmit the physical characteristic to a remote server. In a further example, the instructions may further include instructions to, in response to receiving a message from the remote server after transmitting the physical characteristic to the remote server, output an indication for an operator of the vehicle to service the component. In a yet further example, the message may indicate that the physical characteristic exceeds a threshold.

In an example, the physical characteristic may change over time with use of the component.

In an example, the instructions may further include instructions to adjust a control algorithm for the component based on the physical characteristic.

In an example, the instructions may further include instructions to, in response to the state of the vehicle not satisfying the criterion, actuate the component according to the standard control input.

A method includes, in response to a state of a vehicle satisfying a criterion, actuating a component of the vehicle according to a test control input; and determining a physical characteristic of the component based on data generated as a result of actuating the component according to the test control input. The test control input cycles a magnitude of actuation of the component more frequently than a standard control input cycles the magnitude of actuation. The standard control input is used for actuating the component while the state of the vehicle does not satisfy the criterion.

In an example, the test control input may include at least one periodic component.

In an example, the criterion may include that the vehicle lacks occupants.

In an example, the method may further include determining the physical characteristic by minimizing a difference between the data generated as a result of actuating the component according to the test control input and a reference model simulating the component.

In an example, the method may further include transmitting the physical characteristic to a remote server.

With reference to the Figures, wherein like numerals indicate like parts throughout the several views, a computer 105 includes a processor and a memory, and the memory stores instructions executable by the processor to, in response to a state of a vehicle 100 satisfying a criterion, actuate a component 110 of the vehicle 100 according to a test control input; and determine a physical characteristic of the component 110 based on data generated as a result of actuating the component 110 according to the test control input. The test control input cycles a magnitude of actuation of the component 110 more frequently than a standard control input cycles the magnitude of actuation. The standard control input is used for actuating the component 110 while the state of the vehicle 100 does not satisfy the criterion.

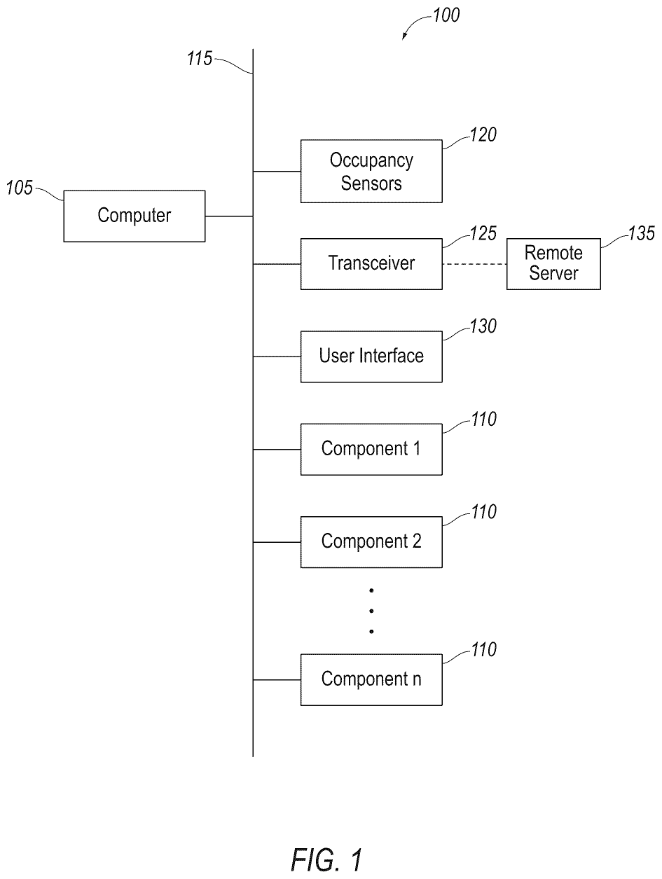

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 115, occupancy sensors 120, a transceiver 125, a user interface 130, and at least one component 110 (e.g., a plurality of components 110) for which at least one physical characteristic (e.g., respective physical characteristics) will be determined as described below.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 115. The communications network 115 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the occupancy sensors 120, the transceiver 125, the user interface 130, and the components 110 via the communications network 115.

The occupancy sensors 120 are configured to detect occupancy of seats in a passenger compartment of the vehicle 100. The occupancy sensors 120 may be visible-light or infrared cameras directed at the seats, weight sensors inside the seats, sensors detecting whether seatbelts for the seats are buckled, or other suitable sensors.

The transceiver 125 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 125 may be adapted to communicate with a remote server 135, that is, a server distinct and spaced from the vehicle 100. Remote servers may be associated with another vehicle (e.g., V2V communications), an infrastructure component (e.g., V2I communications), a first responder, a mobile device associated with the operator of the vehicle 100, etc. The transceiver 125 may be one device or may include a separate transmitter and receiver.

The remote server 135 may be located outside the vehicle 100. The remote server 135 that communicates with the vehicle 100 as described below may be associated with a fleet manager or manufacturer of the vehicle 100. The remote server 135 is a microprocessor-based computing device such as a generic computing device including a processor and a memory. The memory of the remote server 135 can include media for storing instructions executable by the processor as well as for electronically storing data and/or databases, and/or the remote server 135 can include structures such as the foregoing by which programming is provided. The remote server 135 can be multiple computers coupled together.

The user interface 130 presents information to and receives information from an operator of the vehicle 100. The user interface 130 may be located on an instrument panel in a passenger compartment of the vehicle 100, and/or wherever may be readily seen by the operator. The user interface 130 may include dials, digital readouts, screens, speakers, and so on for providing information to the operator, such as human-machine interface (HMI) elements such as are known. The user interface 130 may include buttons, knobs, keypads, microphone, and so on for receiving information from the operator.

The components 110 are actuatable to perform respective tasks within the vehicle 100. For example, the components 110 may include a brake system, a climate-control system, a washer-fluid system, etc. Besides these examples, the components 110 may include others that have physical characteristics that change over time with the use of the component 110, to which the techniques described below may be applicable.

The brake system is typically a conventional vehicle braking subsystem and resists the motion of the vehicle 100 to thereby slow and/or stop the vehicle 100. The brake system may include friction brakes such as disc brakes, drum brakes, band brakes, etc.; regenerative brakes; any other suitable type of brakes; or a combination. The brake system can include an electronic control unit (ECU) or the like that is in communication with and receives input from the computer 105 and/or a human operator. The human operator may control the brake system via, for example, a brake pedal.

The climate-control system provides heating and/or cooling to the passenger compartment of the vehicle 100. The climate-control system may include a compressor, a condenser, a receiver-dryer, a thermal-expansion valve, an evaporator, blowers, fans, ducts, vents, vanes, temperature sensors, and other components that are known for heating or cooling vehicle interiors (specific parts not shown). The climate-control system may operate to cool the passenger compartment by transporting a refrigerant through a heat cycle to absorb heat from the passenger compartment and expel the heat from the vehicle 100, as is known. The climate-control system may include a heater core that operates as a radiator for an engine of the vehicle 100 by transferring some waste heat from the engine into the passenger compartment, as is known. The climate-control system may include an electrically powered heater such as a resistive heater, positive-temperature-coefficient heater, electrically power heat pump, etc.

The washer-fluid system operates to clean a windshield, other windows, and/or sensors of the vehicle 100. The washer-fluid system may include a reservoir, a pump, valves, supply lines, and nozzles (specific parts not shown). The reservoir, the pump, and the nozzles are fluidly connected to each other (i.e., fluid can flow from one to the other). The washer-fluid system distributes washer fluid stored in the reservoir to the nozzles. “Washer fluid” is any liquid stored in the reservoir for cleaning. The washer fluid may include solvents, detergents, diluents such as water, etc. The reservoir may be a tank fillable with liquid. The reservoir may be disposed in a front of the vehicle 100, specifically, in an engine compartment forward of a passenger compartment. The pump may force the washer fluid through the supply lines to the nozzles with sufficient pressure that the washer fluid sprays from the nozzles. Each valve may be positioned and operable to control fluid flow from the pump to one or more of the nozzles. The valves control flow by being actuatable between an open position permitting flow and a closed position blocking flow from the incoming to the outgoing of the liquid supply lines. The supply lines may be, for example, flexible tubes. The nozzles may be aimed at a target to be cleaned (e.g., the windshield, a sensor lens, etc.)

The components 110 each have one or more physical characteristics determinable as described below. For the purposes of this disclosure, a “physical characteristic” is some trait describing a physical structure or physical output of the component 110. For example, the physical characteristics of the brake system may include a thickness for each brake pad. The physical characteristics of the climate-control system may include accumulation on a cabin air filter, maximum airflow rate, etc. The physical characteristics of the washer-fluid system may include washer fluid level in the reservoir, maximum pressure at points in the washer-fluid system, etc. The physical characteristics are static features of the components 110 (i.e., do not change as the control inputs change), for example, a maximum pressure outputtable by the pump of the washer-fluid system rather than a current pressure being outputted by the pump. The physical characteristics are describable with numerical values, such as units of millimeters for the thicknesses of the brake pads, a percentage obstruction of the cabin air filter, etc.

The physical characteristics change over time with use of the respective components 110, in other words, as a result of regular use over an extended period of time. For example, the brake pads slowly become thinner as the brake system is engaged, the cabin air filter becomes more obstructed as air with dust and debris flows through the cabin air filter, and so on. The techniques herein provide a way to track this change instead of (or in addition to) using dedicated sensors for directly measuring the physical characteristics or replacing the part of the component 110 on a regular basis.

For the purposes of this disclosure, a “control input” is defined as one or more values that control operation of a component of a vehicle. The control input may indicate a magnitude of actuation of the component 110. For the purposes of this disclosure, a “magnitude of actuation” is defined as a quantity specifying how much a component is being actuated. For example, the control input may include an input deceleration of the vehicle 100. Actuating the brake system may include engaging the brake system with a braking force resulting in a negative acceleration equal to the input deceleration. For another example, the control inputs for the climate-control system may include a target temperature for the passenger compartment and/or a fan speed. Actuating the climate-control system may include running a heater or air conditioner (depending on whether the current temperature of the passenger compartment is above or below the target temperature) until a difference between the current temperature and the target temperature is within a threshold, and running a fan at the selected fan speed.

The computer 105 may be programmed to actuate the component 110 according to a standard control input. The standard control input is used for actuating the component 110 during typical operation of the vehicle 100 (e.g., while the state of the vehicle 100 does not satisfy the criterion, as described below). In other words, the standard control input is a default control input. The standard control input may be a function of one or more operator-selected values and/or one or more input values. For example, the air conditioner output of the climate-control system may be a function of the difference between the current temperature and the target temperature (i.e., AC=f(T_{act}−T_{targ}), in which AC is the air conditioner output, T_{act} is the current temperature, and T_{targ} is the target temperature). Continuing the example, the air conditioner output may be a linear function of the difference in temperatures (i.e., AC=K*(T_{act}−T_{targ}), in which K is a constant). For another example, the pump output for the washer-fluid system may have a constant positive output for a preset time period after activation and then zero output (i.e., P=f(t)=Pₛₑₜ for t≤tₛₑₜ, 0 for t>tₛₑₜ, in which P is the pump output, Pₛₑₜ is the constant positive output, t is time since activation, and tₛₑₜ is the preset time period).

The computer 105 may be programmed to determine the state of the vehicle 100. For the purposes of this disclosure, a “state” of the vehicle is defined as a condition that the vehicle is operating in or experiencing. For example, the state may include an operating mode or setting of the vehicle 100 (e.g., whether a component 110 is active or currently activatable), a location or type of location of the vehicle 100 (e.g., limited-access highway), a number of occupants of the vehicle 100 (e.g., zero, one, two, etc.), etc.

The computer 105 may determine the state of the vehicle 100 based on data received via the communications network 115. For example, the computer 105 may determine the number of occupants based on data received from the occupancy sensors 120. For another example, the computer 105 may determine whether a component 110 is currently activatable based on data received from that component 110. A component 110 is “currently activatable” if the situational requirements for using the component 110 are satisfied. For example, for the brake system and the washer-fluid system, the situational requirement may be that the vehicle 100 is running. For another example, for the climate-control system, the situational requirements are that the vehicle 100 is running and that the climate-control system is engaged (i.e., switched on).

The computer 105 is programmed to select whether to actuate the component 110 with the standard control input (as described above) or with the test control input (as described below) based on whether the state of the vehicle 100 satisfies a criterion. The criterion defines a subset of possible states of the vehicle 100, and the state of the vehicle 100 is either in the subset of possible states (i.e., satisfies the criterion) or outside the subset of possible states of the vehicle 100 (i.e., does not satisfy the criterion). The computer 105 actuates the component 110 with the test control input in response to the state of the vehicle 100 satisfying the criterion. The computer 105 actuates the component 110 with the standard control input in response to the state of the vehicle 100 not satisfying the criterion.

For example, the criterion may include that the vehicle 100 lacks occupants (i.e., that the number of occupants is zero). States of the vehicle 100 with positive numbers of occupants are outside the subset of possible states defined by the criterion. States of the vehicle 100 with no occupants may be inside the subset of possible states defined by the criterion (depending on whether the criterion includes other requirements).

For another example, the criterion may include that the component 110 is currently activatable. States of the vehicle 100 in which the component 110 is not currently activatable are outside the subset of possible states defined by the criterion. States of the vehicle 100 in which the component 110 is currently activatable may be inside the subset of possible states defined by the criterion (depending on whether the criterion includes other requirements).

The criterion may include multiple requirements. For example, the criterion may include that the component 110 is currently activatable simultaneous with the vehicle 100 lacking occupants. The criterion may include other requirements related to the testability of the physical characteristics (e.g., for the brake system, that the vehicle 100 is in motion).

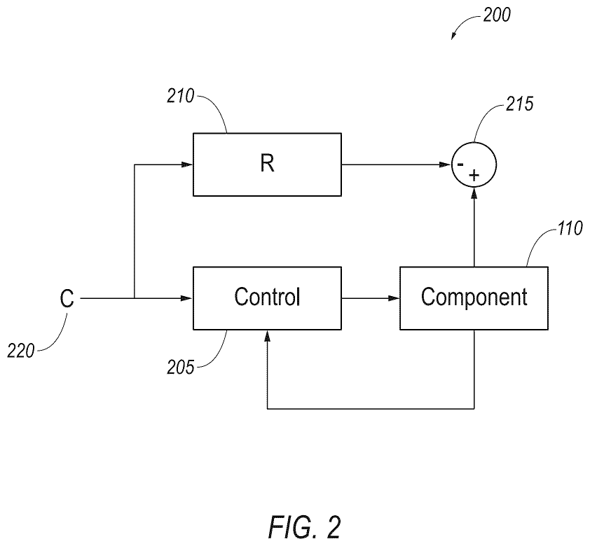

With reference to FIG. 2, the computer 105 may store an architecture 200 for operating one of the components 110. The computer 105 may store a respective architecture 200 for each of the plurality of the components 110. As a general overview, each architecture 200 may include a control algorithm 205 for the component 110, a reference model 210, the component 110, and a difference block 215. The computer 105 is programmed to execute the control algorithm 205, the reference model 210, and the difference block 215. The control algorithm 205 receives a control input 220 and receives data generated as a result of actuating the component 110. The control algorithm 205 actuates the component 110. As the component 110 actuates, the data is generated and is sent to the control algorithm 205 and the difference block 215. The reference model 210 receives the same control input 220 as the control algorithm 205 receives. The reference model 210 simulates the component 110 and outputs reference data to the difference block 215. The reference data is a simulated version of the data generated as a result of actuating the component 110. The difference block 215 determines the difference between the data generated as a result of actuating the component 110 and the reference data. As described below, the computer 105 determines the physical characteristics of the component 110 based on the difference outputted by the difference block 215 while using the test control input.

The computer 105 is programmed to execute the control algorithm 205. The control algorithm 205 receives the control input 220 and actuates the component 110 accordingly. In other words, the control algorithm 205 converts the control input 220 to actuation of the component 110. The control input 220 may be the standard control input as described above or the test control input described below. For example, the control algorithm 205 may receive an air conditioner output AC and actuate the air conditioner to operate at the air conditioner output AC. The control algorithm 205 may receive the pump output P and actuate the pump to push the washer fluid at the pump output P. The control algorithm 205 may receive a braking force B and actuate the braking system to generate the braking force B. The control algorithm 205 may actuate the component 110 based on a value for the physical characteristic stored in the computer 105. For example, the control algorithm 205 may actuate the fan of the climate-control system to spin faster for a given fan speed as the cabin air filter becomes more obstructed.

The component 110 generates data as a result of actuating. The data chosen to send to the control algorithm 205 and the difference block 215 may be relevant for the operation of the component 110. For example, the data for the braking system may include the speed of the vehicle 100 and/or the wheel speeds, as reported by a speedometer, wheel speed sensors, inertial measurement units (IMUs), etc. For another example, the data for the climate-control system may include the temperature of the passenger compartment, an airflow rate through the ducts, fan speed, etc. For another example, the data for the washer-fluid system may include the pump speed, the flowrate, etc.

The reference model 210 is a simulation of the component 110. The reference model 210 may take the control input 220 as an input and estimate the data generated by the component 110 as a result of actuating as an output. The reference model 210 may indicate the change in the state of the component 110 over time as a result of the current state of the component 110 (as indicated by the data generated from actuation) and the control input 220. The “state” of the component 110 refers to some output variable measuring the component 110 (e.g., flowrate). For example, the reference model 210 may be a reference model 210 as used in model reference adaptive control (MRAC), as is known, for example, as in the following expression:

$${\dot{x}}_{m} ( t ) = {A}_{m} {x}_{m} ( t ) + {B}_{m} c ( t )$$

in which xₘ is the state of the reference model 210 (e.g., the simulated output of the component 110), the dot operator indicates a rate of change with respect to time, Aₘ is a constant state matrix, Bₘ is a control effective matrix, and c is the control input 220. The matrices Aₘ, Bₘ may be chosen as a physics-based model of the component 110. The reference model 210 includes value(s) for the physical characteristic(s). For example, the physical characteristics may be incorporated in the matrices Aₘ and/or Bₘ.

The computer 105 uses the test control input for determining the physical characteristics of the component 110. The test control input cycles a magnitude of actuation of the component 110. Cycling the magnitude of actuation means repeatedly increasing the magnitude of actuation from a low value to a high value and then decreasing the magnitude of actuation back to the low value (or vice versa). The low value may be zero (e.g., off or resting or inactive), and the high value may be a positive value (e.g., a preset value when turned on). For example, the pump output P may equal 0 or Pₛₑₜ, as described above. Alternatively, the low value may be a positive value, the high value may be a greater positive value, and the magnitude of actuation may vary (e.g., continuously) between the low value and the high value.

The test control input cycles a magnitude of actuation of the component 110 more frequently than the standard control input cycles the magnitude of actuation. For example, the standard control input may not cycle the magnitude of actuation at all (e.g., by operating the component 110 without a repeating pattern), and the test control input may cycle the magnitude of actuation. For another example, the standard control input may cycle the magnitude of actuation at a first frequency, and the test control input may cycle the magnitude of actuation at a second frequency that is greater than the first frequency. The higher frequency helps an estimate of the physical characteristic converge to a globally optimal estimate rather than a locally optimal estimate, thereby increasing the accuracy of the physical characteristic as determined below.

The test control input may include at least one periodic component. The term “periodic” is used in its mathematical sense as describing a function whose value repeats after the regular addition of a constant period to its independent variable (i.e., f(x+k)=f(x) for all x). The use of a periodic component can produce the cycling of the magnitude of actuation. For example, the test control input may include a number of periodic components at least as great as a number of the physical characteristics of the component 110 that are being determined. The periodic components are functions of time. The periodic components of a test control input may have different frequencies than each other. The periodic components may be sinusoidal, as given in the following example expression:

$$c ( t ) = {\sum }_{i = 1}^{I} sin ( {f}_{i} t ) , {f}_{i} \neq {f}_{j} for all i \neq j$$

in which i and j are indices of the periodic components, I is the total number of periodic components, and fᵢ is the frequency of the ith periodic component. The use of this number of periodic components with different frequencies can help reach globally optimal estimates of each physical characteristic, rather than of only some of the physical characteristics.

The computer 105 may be programmed to receive the test control input. For example, the computer 105 may receive the test control input in a message from the remote server 135 via the transceiver 125. The remote server 135 may be programmed to determine the test control input. The message may also include a duration of time for which to use the test control input.

The computer 105 is programmed to actuate the component 110 according to the test control input. The computer 105 may execute the control algorithm 205 to actuate the component 110, with the test control input being inputted to the control algorithm 205 rather than the standard control input. For example, the computer 105 may actuate the component 110 according to the test control input for the duration of time received in the message with the test control input, and then the computer 105 may cease actuating the component 110 according to the test control input (e.g., by actuating the component 110 according to the standard control input or ceasing actuating the component 110 at all).

The computer 105 may receive the data generated as a result of actuating the component 110 according to the test control input (i.e., the data generated during the duration of time that the computer 105 is actuating the component 110 with the test control input). This data is used for determining the physical characteristics of the component 110. Data generated as a result of actuating the component 110 according to the standard control input may be ignored (i.e., not used) by the computer 105 for the purposes of determining the physical characteristics (though the data may be used for other purposes).

The computer 105 is programmed to determine the physical characteristic(s) of the component 110 based on the data generated as a result of actuating the component 110 according to the test control input. “Determining the physical characteristic” refers to estimating a value of the physical characteristic. The computer 105 may determine the physical characteristics by comparing the data generated as a result of actuating the component 110 according to the test control input and the data outputted by the reference model 210 over the same timeframe. A deviation between the reference model 210 and the data generated from the test control input indicates that the values for the physical characteristics contained in the reference model 210 deviate from the actual values of the physical characteristics. The computer 105 may determine the physical characteristic by minimizing the difference between the data generated as a result of actuating the component 110 according to the test control input and the reference model 210. The computer 105 may iteratively update the values for the physical characteristics in the reference model 210 based on the difference from the difference block 215 and re-determine the difference in the difference block 215. The computer 105 may use any suitable optimization algorithm to minimize the difference. For example, the computer 105 may execute a Brandt-Lin learning algorithm. The computer 105 may execute the optimization algorithm for a preset number of iterations or until the difference falls below a threshold chosen to indicate convergence. As indicated above, the use of a periodic test control input and the use of a number of periodic components permits the optimization algorithm (e.g., the Brandt-Lin algorithm) to converge on a global minimum of the difference instead of on a local minimum of the difference.

The computer 105 may be programmed to adjust the control algorithm 205 for the component 110 based on the physical characteristic as determined by the optimization algorithm. For example, the computer 105 may update the value(s) for the physical characteristic(s) in the reference model 210, and the control algorithm 205 may use model reference adaptive control (MRAC). As is known, in MRAC, a gain applied to the control input within the control algorithm 205 is based on the difference between the outputs of the reference model 210 and the component 110 (i.e., the difference from the difference block 215). Updating the reference model 210 thereby updates the control algorithm 205.

The computer 105 may be programmed to output an indication for an operator of the vehicle 100 to service the component 110 in response to the physical characteristic exceeding a threshold. The threshold may be chosen to indicate that a part of the component 110 being serviced has exceeded a proportion of its useful life. For example, the computer 105 may, upon determining the physical characteristic, instruct the transceiver 125 to transmit the physical characteristic to the remote server 135. The remote server 135 may be programmed to determine whether the physical characteristic exceeds the threshold and, if so, transmit a message back to the computer 105 indicating that the physical characteristic exceeds the threshold. The threshold may vary depending on other circumstances affecting the vehicle 100 or other physical characteristics of the component 110, and the remote server 135 may determine the value of the threshold. The computer 105 may instruct the user interface 130 to output the indication by, for example, illuminating a light, displaying a preset message, emitting a chime, etc.

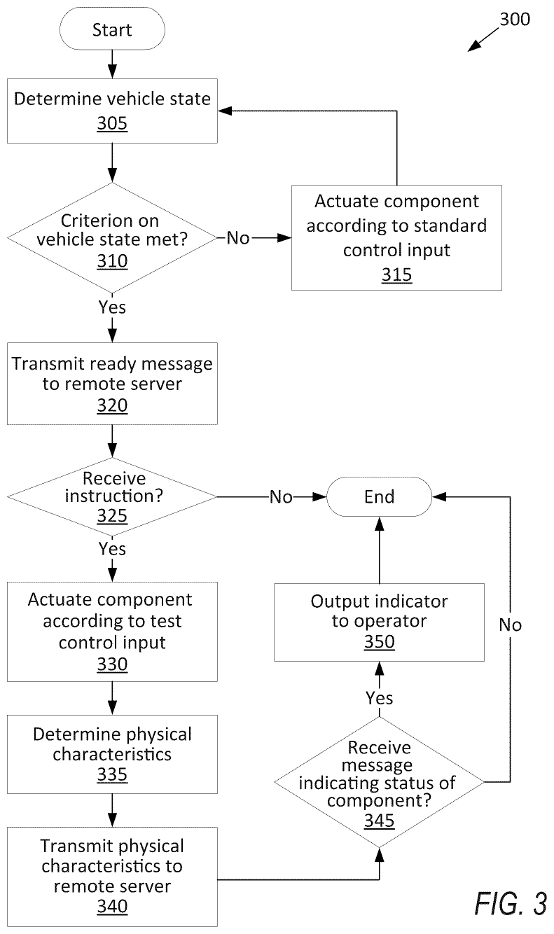

FIG. 3 is a flowchart illustrating an example process 300 for controlling the component 110 and determining the physical characteristics of the component 110. The memory of the computer 105 stores executable instructions for performing the steps of the process 300 and/or programming can be implemented in structures such as mentioned above. As a general overview of the process 300, the computer 105 determines the state of the vehicle 100 and determines whether the state satisfies the criterion. If not, the computer 105 actuates the component 110 according to the standard control input. If so, the computer 105 transmits a message to the remote server 135. Upon receiving the test control input from the remote server 135, the computer 105 actuates the component 110 according to the test control input, determines the physical characteristics of the component 110 based on the resulting data, and transmits the physical characteristics to the remote server 135. In response to a message from the remote server 135 indicating that the physical characteristics exceed a threshold, the computer 105 outputs an indication for an operator of the vehicle 100 to service the component 110.

The process 300 begins in a block 305, in which the computer 105 determines the state of the vehicle 100, as described above.

Next, in a decision block 310, the computer 105 determines whether the state of the vehicle 100 from the block 305 satisfies the criterion, as described above. In response to the state of the vehicle 100 not satisfying the criterion, the process 300 proceeds to a block 315. In response to the state of the vehicle 100 satisfying the criterion, the process 300 proceeds to a block 320.

In the block 315, the computer 105 actuates the component 110 according to the standard control input, as described above. After the block 315, the process 300 returns to the block 305 to continue monitoring the state of the vehicle 100.

In the block 320, the computer 105 transmits a message to the remote server 135 indicating that the vehicle 100 is ready to actuate the component 110 according to the test control input (e.g., via the transceiver 125). The message may indicate that the state of the vehicle 100 satisfies the criterion.

Next, in a decision block 325, the computer 105 determines whether the computer 105 received the test control input from the remote server 135, as described above. The computer 105 may determine whether the computer 105 received the test control input within a time limit from transmitting the message in the block 320. The time limit may be chosen to be longer than a routine amount of time to receive a response from the remote server 135. In response to not receiving the response with the test control input within the time limit, the process 300 ends. In response to receiving the test control input from the remote server 135 after transmitting the message to the remote server 135, the process 300 proceeds to a block 330.

In the block 330, the computer 105 actuates the component 110 according to the test control input, as described above.

Next, in a block 335, the computer 105 determines the physical characteristic(s) of the component 110 based on the data generated in the block 330 as a result of actuating the component 110 according to the test control input, as described above.

Next, in a block 340, the computer 105 transmits the physical characteristic(s) to the remote server 135, as described above.

Next, in a decision block 345, the computer 105 determines whether the computer 105 received a message from the remote server 135 after transmitting the physical characteristics to the remote server 135 in the block 340. As described above, the message indicates that the physical characteristic exceeds a threshold. In response to receiving the message, the process 300 proceeds to a block 350. In response to not receiving the message, the process 300 ends.

In the block 350, the computer 105 outputs the indication for an operator of the vehicle 100 to service the component 110, as described above. After the block 350, the process 300 ends.

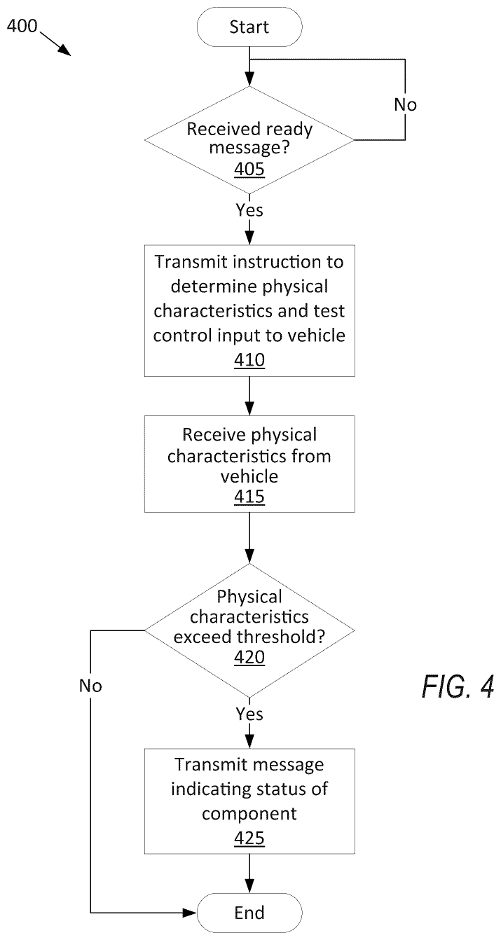

FIG. 4 is a flowchart illustrating an example process 400 for evaluating the physical characteristics of the component 110. The memory of the remote server 135 stores executable instructions for performing the steps of the process 400 and/or programming can be implemented in structures such as mentioned above. As a general overview of the process 400, the remote server 135 determines whether it received a message indicating that the vehicle 100 is ready to determine the physical characteristics of the component 110. Once the remote server 135 receives the message, the remote server 135 transmits a message including the test control input to the computer 105 on board the vehicle 100 and receives the physical characteristics back from the computer 105. In response to the physical characteristics exceeding the threshold, the remote server 135 transmits the message indicating that the physical characteristics exceed the threshold to the computer 105.

The process 400 begins in a decision block 405, in which the remote server 135 determines whether the remote server 135 has received a message indicating that the state of the vehicle 100 satisfies the criterion (as sent in the block 320 of FIG. 3). In the absence of the message, the process 400 remains at the decision block 405 for the remote server 135 to wait until receiving the message. In response to receiving the message, the process 400 proceeds to a block 410.

In the block 410, the remote server 135 transmits the message to the vehicle 100, as described above. The message includes the test control input and possibly the duration of actuating the component 110 according to the test control input.

Next, in a block 415, the remote server 135 receives the physical characteristics of the component 110 in a message from the vehicle 100 (as sent in the block 340 of FIG. 3).

Next, in a decision block 420, the remote server 135 determines whether the physical characteristics exceed a threshold, as described above. In response to the physical characteristics falling below the threshold, the process 400 ends. In response to the physical characteristics exceeding the threshold, the process 400 proceeds to a block 425.

In the block 425, the remote server 135 transmits the message indicating that the physical characteristics exceed the threshold, as described above. After the block 425, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. Use of “in response to,” “upon determining,” “upon receiving,” etc. indicates a causal relationship, not merely a temporal relationship. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
in response to a state of a vehicle satisfying a criterion, actuate a component of the vehicle according to a test control input, the test control input cycling a magnitude of actuation of the component more frequently than a standard control input cycles the magnitude of actuation, the standard control input used for actuating the component while the state of the vehicle does not satisfy the criterion; and
determine a physical characteristic of the component based on data generated as a result of actuating the component according to the test control input.

2. The computer of claim 1, wherein the test control input includes at least one periodic component.

3. The computer of claim 1, wherein the instructions further include instructions to determine a plurality of physical characteristics of the component based on the data generated as a result of actuating the component according to the test control input.

4. The computer of claim 3, wherein the test control input includes a number of periodic components at least as great as a number of the physical characteristics of the component, the periodic components having different frequencies than each other.

5. The computer of claim 1, wherein the criterion includes that the vehicle lacks occupants.

6. The computer of claim 5, wherein the criterion includes that the component is currently activatable simultaneous with the vehicle lacking occupants.

7. The computer of claim 1, wherein the instructions further include instructions to determine the physical characteristic by minimizing a difference between the data generated as a result of actuating the component according to the test control input and a reference model simulating the component.

8. The computer of claim 1, wherein the instructions further include instructions to, in response to the state of the vehicle satisfying the criterion, transmit a message to a remote server indicating that the vehicle is ready to actuate the component according to the test control input.

9. The computer of claim 8, wherein the instructions further include instructions to, in response to receiving the test control input from the remote server after transmitting the message to the remote server, actuate the component according to the test control input.

10. The computer of claim 1, wherein the instructions further include instructions to transmit the physical characteristic to a remote server.

11. The computer of claim 10, wherein the instructions further include instructions to, in response to receiving a message from the remote server after transmitting the physical characteristic to the remote server, output an indication for an operator of the vehicle to service the component.

12. The computer of claim 11, wherein the message indicates that the physical characteristic exceeds a threshold.

13. The computer of claim 1, wherein the physical characteristic changes over time with use of the component.

14. The computer of claim 1, wherein the instructions further include instructions to adjust a control algorithm for the component based on the physical characteristic.

15. The computer of claim 1, wherein the instructions further include instructions to, in response to the state of the vehicle not satisfying the criterion, actuate the component according to the standard control input.

16. A method comprising:
in response to a state of a vehicle satisfying a criterion, actuating a component of the vehicle according to a test control input, the test control input cycling a magnitude of actuation of the component more frequently than a standard control input cycles the magnitude of actuation, the standard control input used for actuating the component while the state of the vehicle does not satisfy the criterion; and
determining a physical characteristic of the component based on data generated as a result of actuating the component according to the test control input.

17. The method of claim 16, wherein the test control input includes at least one periodic component.

18. The method of claim 16, wherein the criterion includes that the vehicle lacks occupants.

19. The method of claim 16, further comprising determining the physical characteristic by minimizing a difference between the data generated as a result of actuating the component according to the test control input and a reference model simulating the component.

20. The method of claim 16, further comprising transmitting the physical characteristic to a remote server.
